(19) United States
(12) Patent Application Publication
(10) Pub. No.: US 2007/0105706 A1
(43) Pub. Date: May 10, 2007

(54) Ceramic Armor

(75) Inventors: Hsi-Ching Bryan Chen, San Diego, CA (US); Lester L. Begg, San Diego, CA (US); Bodjema S. Bohedba, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: General Atomics, San Diego, CA (US)

(21) Appl. No.: 11/421,693

(22) Filed: Jun. 1, 2006

Related U.S. Application Data
(60) Provisional application No. 60/688,131, filed on Jun. 6, 2005.

(51) Int. Cl. C04B 35/563; C04B 35/565; C04B 35/58; C04B 35/653

(52) U.S. Cl. 501/87; 501/88; 501/91; 501/92; 501/96.3; 264/332

(57) ABSTRACT

A dense, hard body having good fracture toughness, hardness and a high capacity to absorb impacts which is also useful as lightweight armor. The body is an eutectic of either (a) two carbides selected from boron carbide (B₄C), silicon carbide (SiC), titanium carbide (TiC), tantalum carbide (TaC), tungsten carbide (WC), zirconium carbide (ZrC) and hafnium carbide (HfC); or (b) one of the above carbides and at least one boride of an element of group IVa, Va or VIa of the Periodic Table. The molten eutectic, e.g. a ternary composition of B₄C, SiC and TiB₂, may be generally directionally cooled so its lamellar microstructure is oriented relative to a large surface of the body.

This application claims priority from U.S. Provisional Application Ser. No. 60/688,131, filed Jun. 6, 2005.

### FIELD OF THE INVENTION

The invention relates generally to armor and other structures made of ceramic materials, and more particularly to methods of making impact-resistant bodies from non-oxide eutectic materials which have high fracture toughness.

### BACKGROUND OF THE INVENTION

During the last few decades, efforts have been made to produce ceramic-based armors which will be lower in mass than metals and thus be potentially more suitable for applications where weight is of significant importance, for example aircraft armor and armor for the human body. Some of these efforts have looked towards silicon carbide as a potential candidate for such applications whereas others have use fiber-reinforced ceramic materials.

U.S. Pat. No. 6,709,736 proposes the use of carbon or graphite fibers to reinforce a ceramic matrix which contains at least 10% silicon carbide and is produced by pyrolysis. U.S. Pat. No. 6,805,034 proposes the production of a ballistic armor having a performance that is said to at least approach that of alumina or hot-pressed boron carbide armors, it would use silicon carbide, titanium carbide or titanium diboride and infiltrate a molten material into a permeable mass and reacting the infiltrant to form silicon carbide.

None of these ceramic armors produced to date have been considered to be entirely satisfactory, and thus the search has gone on for processes for producing more effective ceramic armors.

### SUMMARY OF THE INVENTION

It has been found that a lightweight body armor or other armor where weight is of significant concern can be made from combinations of non-oxide refractory materials and particularly from combinations which include refractory carbides. The products that resulted are believed to also have other applications where high impact resistance and/or fracture toughness is important. It has been found that combinations which include either 2 carbides of the following elements: boron, silicon, titanium, tungsten, zirconium and hafnium, or which include one or more of the foregoing carbides, plus a boride of an element of Group IVa, Va or VIa of the Periodic Table can be produced by using powder mixtures to directly form a molten eutectic and then cooling the eutectic in a manner such as to create an oriented lamellar microstructure that will impart desired physical properties to the resultant body. The result of such a process is a body which has a high capacity to absorb multiple impacts, particularly impacts in a direction transverse to a surface that is generally parallel to these lamellae, and which has high fracture toughness.

In one particular aspect, the invention provides a method of making an armor body having a thickness sufficient to stop a bullet impacting against a surface of greater dimension than this thickness. A mixture of particulate materials is heated to a temperature sufficient to form a molten eutectic, which mixture includes at least: (a) two carbides selected from boron carbide, silicon carbide, titanium carbide, tantalum carbide, tungsten carbide, zirconium carbide and hafnium carbide; or (b) one of the above said carbides plus at least one boride of an element of group IVa, Va or VIa of the Periodic Table. The molten eutectic is cooled under controlled conditions such that a body is formed having a lamellar microstructure that is directionally oriented relative to a desired surface, whereby the body that results has a high capacity to absorb impacts against such surface and has high fracture toughness.

In another particular aspect, the invention provides an armor body which comprises a structure having a thickness sufficient to stop a bullet when impacting against a surface of greater dimensions. The body consists essentially of an eutectic composition which comprises either (a) two carbides selected from boron carbide, silicon carbide, titanium carbide, tantalum carbide, tungsten carbide, zirconium carbide and hafnium carbide; or (b) one of the above carbides and at least one boride of an element of group IVa, Va or VIa of the Periodic Table. A lamellar microstructure of the body is directionally oriented generally parallel to the surface thereof, whereby said armor body has a high capacity to absorb impacts and has a high fracture toughness.

In a further particular aspect, the invention provides dense, hard body having good fracture toughness. The body consists essentially of an eutectic composition that comprises either (a) two carbides selected from boron carbide (B₄C), silicon carbide (SiC), titanium carbide (TiC), tantalum carbide (TaC), tungsten carbide (WC), zirconium carbide (ZrC) and hafnium carbide (HfC); or (b) one of the above said carbides and at least one boride of an element of group IVa, Va or VIa of the Periodic Table. The body has a lamellar microstructure that is directionally oriented generally parallel to a desired surface of the body, whereby the body has a high capacity to absorb impacts against the surface and has a high fracture toughness.

### DETAILED DESCRIPTION OF THE PREFERRED EMBODIMENTS

Although carbides and borides have been well known as candidates for producing armor materials because of their general high strength, hardness, elastic modulus, sonic velocity and lightweight, the brittleness of these materials has posed a problem. Frequently such materials have fractured or fragmented upon ballistic impact, and as a result, it has heretofore been generally necessary to confine such ceramic armors within a metal cladding or a fiber-reinforced composite to preserve the ability of the armor to resist more than a single impact. Accordingly, an objective has been to overcome such disadvantages shown by ceramic materials of this general type so as to better utilize the potentially worthwhile attributes of these materials and possibly eliminate the need for metal confinement.

It has been found that certain refractory compounds can be used to produce ceramics having an aligned, lamellar microstructure which will enhance the bond strength between phases and improve the overall strength and stability of the solid body that results. They can be made in essentially any desired shape, e.g. flat or arcuate plates, tubes, rods, etc. The starting materials that have been found useful to produce such structures are mixtures of refractory carbides and/or refractory borides, which include at least one carbide, in ratios close to the desired eutectic stoichiometric ratio. The term “refractory” is used to identify a compound having a melting point of at least about 2000° C. Carbides of silicon (Si), boron (B), titanium (Ti), tantalum (Ta), tungsten (W), Zirconium (Zr) and hafnium (Hf) may be used. Binary or ternary systems may include a boride of an element of Group IVa, Va or VIa of the Periodic Table and preferably of a Group IVa metal. Examples of preferred eutectics include the boron carbide-silicon carbide eutectic and eutectics made employing one or both of these carbides together with at least one such boride. Reference herein is always made to the IUPAC form of the Periodic Table wherein e.g. Group IVa includes Ti, Zr and Hf Preferred members of this group of potential borides include titanium boride and zirconium boride. These carbides and borides are employed as the compounds: B₄C, SiC, TiC, TaC, WC, ZrC, HfC, TiB₂ and ZrB₂; however, there may be included minor amounts of the elements in other oxidation states which should be understood to be comprehensively included.

Manufacture of the products should be carried out in a vacuum or under an inert atmosphere, such as argon, and mixtures of particulate forms, e.g. powders of the starting materials or precursors thereof, are preferably melted in molds that have the desired form of the product itself. Alternatively, they may be melted in a crucible or the like, and the melt poured into a mold where it is cooled. The mold and/or crucible should, of course, be made of suitable high temperature material, and preferably, it is precoated with a suitable coating so as to avoid contamination of the resultant eutectic material from the material of the crucible, e.g. graphite, boron carbide or boron nitride. Inert compounds, such as sintered TiB₂ or HfC/HfB₂, may be used to coat crucibles or molds that are designed to withstand temperatures in the range of 2000 to 2500° C. For example, a mold may be first treated with a paste which is then fired to form a barrier layer. Refractory carbides, such as tantalum carbide (TaC), niobium carbide (NbC), zirconium carbide (ZrC), and hafnium carbide (HfC) have high melting points and chemical stability and may be used as container liners for a ceramic eutectic melt. Such carbide container liners can be formed by carburization of tantalum, niobium, zirconium, or hafnium provided through a solid state diffusion method or by a gas infiltration method. They can also be formed by traditional CVD or sintering methods. However, it is uncertain whether minute amounts of contamination would be in any way detrimental to the physical properties of the resultant products.

The production process is carried out by producing a powder mixture where there is an intimate interdispersion of the particles, preferably by ball milling or the like to a particle size of about 2 μm or less. The powder mixture, having the desired ratio of starting materials to form the desired eutectic composition, is heated under an inert atmosphere to a temperature where the molten eutectic forms so that all of the starting materials are in molten solution. To be assured that this is the case, it may be desirable to heat to a temperature at least about 50° C. above the eutectic temperature, both because it may be difficult to precisely measure temperature in this high range and because the eutectic point or temperature will usually be significantly below the melting points of one or more of the individual components that are here involved.

Once the desired molten condition has been attained, the mold containing the molten eutectic material is moved into a cold zone which is designed to achieve a controlled directional solidification. For example, if the bottom surface of the mold is flat, and it is desired that the lamellar microstructure should be generally parallel to this substantially flat bottom surface, cooling is carried out through the bottom surface of the mold. On the other hand, if the mold has an arcuate curvature and if it is desired that the lamellar microstructure be essentially parallel to that arcuate surface, cooling is carried out through the interior arcuate surface or the exterior surface. Cooling is preferably carried out under an inert atmosphere, and in a manner to avoid creation of voids in the resultant microstructure. In this respect, a cooling rate between about 5° C. and about 15° C. per minute is preferably initially used, i.e. until a temperature of at least about 200° below the eutectic temperature has been reached, more preferably until at about 1900° C. has been reached, and most preferably to at least about 1800° C. At this point, cooling may be increased to a rate of about 100° C. to 200° C. per minute. By directionally cooling these products in this manner, the resultant bodies are oriented to have surfaces of high fracture toughness, i.e. greater than about 4 MPa\sqrt{m} and often greater than about 7 MPa\sqrt{m} can be obtained. High hardness is also a property of these products, i.e. about 2400 kg/mm² or greater on the Knoop scale.

The relatively lightweight products that result are effective armor because the oriented surfaces are able to absorb impact energy from a bullet or other projectile by redirecting cracks laterally without fragmenting or fracturing through the thickness of the body, and as a result, the bodies are able to withstand multiple impacts against such surfaces which will be of substantially greater dimension then the thickness, at least by a factor of about 5 or 10. As such, the products are useful in personal body armor vests and lightweight plating for aircraft and the like, where weight is of very important consideration. Their impact resistance and fracture toughness also makes them excellent candidates for other products, such as turbine blades, engine components, and other applications where fracture toughness is important, particularly those products destined for operation in a high temperature environment. Although it was earlier known that eutectic compositions of ZrC-ZrB₂ and TiC-TiB₂, for example, would form columnar grains having a lamellar microstructure when a sintered rod was subjected to floating-zone melting and then solidified, the value of the resultant product was believed to lie in its improved high temperature stability, see “Directional Solidification of (Ti, Zr) Carbide—(Ti, Zr) Diboride Eutectic”, C. C. Sorrell, et al., J. Am. Ceramic Society, 67, 3, 190-194 (March 1984).

To be useful, for example, as body armor, it is considered that the eutectic body, e.g. in plate form, should have a thickness sufficient to stop an armor-piercing bullet, which has a mass of about 11 grams and is moving with a velocity as high as about 900 meters per second, from penetrating. Generally such eutectic materials should be at least about 5 mm thick and preferably at least about 7.5 mm thick. Assuming the armor is in generally plate form, it will normally have at least one dimension, and preferably two dimensions, that are more than 10 times the thickness of the plate. Some forms of the armor may be used without metal confinement, i.e. with only fabric, e.g. polyaramid fiber, confinement, or with none at all.

Investigations have shown that mixtures of these refractory materials of carbides or carbides and borides have eutectic melting points at their eutectic compositions which are well below the melting points of the pure starting materials. For example, whereas the melting points of boron carbide and silicon carbide are respectively about 2450° C. and about 2760° C., the eutectic has a melting point of only about 2300° C. The contrast is even more striking when one of the preferred metal borides is used. Zirconium diboride and titanium diboride have melting points of about 3245° C. and 3225° C., respectively. However, the titanium diboride/silicon carbide eutectic has a melting point of only about 2187° C.

It is important that the mixtures of the starting materials used in production should have a composition very close to the eutectic composition. Although the eutectic may dissolve small amounts of one or more of the ingredients, it is important that there not be a significant excess of one of the ingredients, or perhaps two of the ingredients if a three ingredient eutectic is being used, and preferably any excess should not be by more than about 5 weight %. In this respect, the eutectic composition, by weight, of titanium diboride and silicon carbide is 45/55, and the eutectic composition, by weight, of silicon carbide and boron carbide is about 45% SiC and 55% B₄C. The eutectic composition of zirconium diboride and boron carbide is 52/48, and the eutectic composition of zirconium diboride and silicon carbide is 51/49. The eutectic composition of titanium diboride and boron carbide is 15/85, and the ternary eutectic composition of boron carbide/silicon carbide/titanium boride, in parts by weight, falls within the range of (54-72)/(15-27)/(10-23).

The following examples set forth experiments that are carried out to show production of ceramic materials having a microstructure suitable for use as a lightweight armor; however, they should be understood to be exemplary only and not to constitute limitations upon the scope of the invention, which is defined in the claims appended hereto.

### EXAMPLE 1

A titanium diboride/silicon carbide eutectic body is made using the following procedure. High purity TiB₂ and high purity SiC (both greater than 99% pure) are obtained in powder form and mixed by dry blending. 55 weight % SiC powder and 45 weight % TiB₂ are used. Dry blending is carried out by ball milling with zirconia grinding media of 0.5″ size for about four hours. The resultant powder is sieved through a −325 mesh screen to break up any agglomerates, and the powder mixture is formed into 1″ diameter pellets by cold isostatic pressing at 50,000 psi.

Graphite crucibles are prepared for use in the a high temperature operation so as to minimize contamination of the materials being fired. A dense coating is applied to the crucibles. Hafnium carbide and hafnium diboride powders are mixed in a 70/30 weight ratio and ball milled for 24 hours with half-inch zirconia grinding media. After screening to −325 mesh to eliminate agglomerates, the powders are slurried with a suspension of 1% hydroxypropyl cellulose in ethyl alcohol and mixed for about 15 minutes. The slurry is applied to the interior surfaces of the graphite crucible, and the crucible is baked for about 24 hours at about 125° C. to first dry out the slurry. After bakeout, the crucibles are fired in a high temperature furnace, at about 2500° C. in argon, to reaction sinter the hafnium powders and produce a dense, noncontaminating coating which is resistant to carbon migration therethrough. Similar coatings can be produced on graphite crucibles, using a 40/60 weight ratio of zirconium carbide and zirconium boride powders, via the same procedure and reaction sintering at about 2400° C. in argon. Another alternative coating may be made using a slurry of titanium diboride and reaction sintering at about 2450° C. in argon. Double-coated graphite crucibles may also be provided, e.g. by first coating with a hafnium carbide/hafnium boride slurry and, after such coating is complete, applying a titanium diboride coating using the same procedure as described hereinbefore.

The cold-pressed pellets are placed in such a coated graphite crucible, which is covered and placed in a high temperature furnace having an atmosphere of argon. Heating is carried out at a temperature increase of about 125° C. per minute until reaching a temperature of about 2240° C. (about 50° C. above the melting point of the eutectic), and the pellet is held at this temperature for about 10-15 minutes. Temperatures are measured by means of an optical pyrometer.

Cooling of the molten mass in the crucible is directionally carried out, and the rate of cooling is regulated. The sample is cooled down to about 1800° C. at a rate of about 10° C. per minute. Thereafter, cooling to ambient is allowed to occur at about 200° C. per minute. By directionally cooling the molten mass, control of the orientation of the microstructure can be obtained, and it is found that the laminae of the microstructure is predominantly in a direction parallel to the surface of the molten mass from which heat is withdrawn in the cooling process. Examination of the resultant crystalline structure shows a predominantly eutectic lamellar microstructure with minor regions of SiC and regions of TiB₂. The resultant structure exhibits good fracture toughness.

### EXAMPLE 2

A silicon carbide/boron carbide eutectic composition is made using the procedure as set forth in Example 1. Commercially available silicon carbide and boron carbide powders, having particle sizes of less than about 2 microns, in amounts of 30 weight % of silicon carbide and 70 weight % of boron carbide, are ball-milled to create an intimate interdispersion. Ball milling is followed by sieving through −325 mesh screen size to eliminate agglomerates and cold isostatic pressing at 50,000 psi. Heating is carried out to raise the temperature at a rate of about 125° C. per minute to a temperature of about 2350° C., which is about 50° C. above the eutectic point, where the temperature is held for about 5-10 minutes.

Cooling of the molten mass in the crucible is directionally carried out, and the rate of cooling is again regulated. The sample is cooled down to about 1800° C. at a rate of about 10° C. per minute. Thereafter, cooling to ambient is allowed to occur at about 200° C. per minute. By directionally cooling the molten mass, control of the orientation of the microstructure can be obtained, and it is found that the laminae of the microstructure is predominantly in the direction parallel to the surface of the molten mass from which heat is withdrawn in the cooling process. Examination of the resultant crystalline structure shows a predominantly eutectic lamellar microstructure with minor regions of B₄C and regions of SiC. The resultant structure exhibits good fracture toughness.

### EXAMPLE 3

A titanium diboride/boron carbide eutectic body is made, again using the procedure set forth in Example 1. Mixtures of powders that are reduced in size to less than about 2 microns are employed, and about 85 weight % boron carbide and 15 weight % titanium diboride are employed. The procedure as described hereinbefore is followed, heating to a temperature of about 2360° C. where it is held for about 5-10 minutes so that substantially the entire composition is in molten form. Initial cooling is directionally carried out as described before at a rate of about 10° C. per minute down to about 1800° C. Thereafter, cooling to ambient is allowed to occur at about 200° C. per minute. By directionally cooling the molten mass, control of the orientation of the microstructure can be obtained, and it is found that the laminae of the microstructure is predominantly in the direction parallel to the surface of the molten mass from which heat is withdrawn in the cooling process. Examination of the resultant crystalline structure shows a predominantly eutectic lamellar microstructure with minor regions of B₄C and regions of TiB₂. The resultant structure exhibits good fracture toughness.

### EXAMPLE 4

A zirconium boride/silicon carbide eutectic body is made; the general procedure of Example 1 is followed. The powders are premilled to produce a particle size of not greater than about 2 microns, and about 51 weight % zirconium boride and 49 weight % silicon carbide is employed. Heating is carried out to a temperature of about 2325° C., about 50° C. above the eutectic point, and that temperature is held for about 5-10 minutes. Directional cooling to 1800° C. at a rate of about 110° C. per minute is again followed. Thereafter, cooling to ambient is allowed to occur at about 200° C. per minute. By directionally cooling the molten mass, control of the orientation of the microstructure is obtained, and it is found that the laminae of the microstructure is predominantly in the direction parallel to the surface of the molten mass from which heat is withdrawn in the cooling process. Examination of the resultant crystalline structure shows a predominantly eutectic lamellar microstructure with minor regions of SiC and regions of ZrB₂. The resultant structure exhibits good fracture toughness.

### EXAMPLE 5

A zirconium boride/boron carbide eutectic body is made; the general procedure of Example 1 is followed. Powders are pre-ball milled to produce a particle size not greater than about 2 microns. Amounts of about 52 weight % zirconium boride powder and 48 weight % boride carbide powder are employed. Heating is to a temperature of about 2270° C., which is about 50° C. above the eutectic point. The sample is directionally cooled down to about 1800° C. at a rate of about 110° C. per minute; thereafter, cooling to ambient is allowed to occur at about 200° C. per minute. By directionally cooling the molten mass, control of the orientation of the microstructure is obtained, and it is found that the laminae of the microstructure is predominantly in the direction parallel to the surface of the molten mass from which heat is withdrawn in the cooling process. Examination of the resultant crystalline structure shows a predominantly eutectic lamellar microstructure with minor regions of B₄C and regions of ZrB₂. The resultant structure exhibits good fracture toughness.

### EXAMPLE 6

A ternary eutectic body is made from titanium diboride, boron carbide and silicon carbide. The ternary eutectic can vary in composition from about 54 to 72% boron carbide, 15 to 27% silicon carbide and 10 to about 23% titanium boride. For purposes of this experiment, 54.4 weight % boron carbide, 23.3 weight % silicon carbide and 22.3 weight % titanium boride powders are employed; the powders are not greater than about 2 microns in size and are ball milled to create an intimate interdispersion. This relative weight composition appears to have about the lowest eutectic temperature, i.e. about 2100° C.; it is nearly 100° C. lower than the titanium boride/silicon carbide eutectic which is the lowest of the three binary eutectics made from these starting materials. Accordingly, the temperature is raised to about 2150° C. (about 50° C. above this eutectic temperature) and held at this point for about 5-10 minutes to assure the substantially entire molten condition. Cooling, as described before, is then directionally carried out at a rate of about 10° C. per minute to about 1800° C.; thereafter, cooling to ambient is allowed to occur at about 200° C. per minute. By directionally cooling the molten mass, control of the orientation of the microstructure is obtained, and it is found that the laminae of the microstructure is predominantly in the direction parallel to the surface of the molten mass from which heat is withdrawn in the cooling process. Examination of the resultant crystalline structure shows a predominantly eutectic lamellar microstructure with only minor regions of SiC, B₄C and TiB₂. The resultant structure exhibits good fracture toughness.

### EXAMPLE 7

Another titanium diboride/silicon carbide eutectic body was made, which contained 55 weight % SiC and 45 weight % TiB₂, using the procedure generally as described in Example 1. Wet milling was carried out by ball milling with zirconia grinding media of about 0.5″ size and 200 proof ethanol for 24 hours. The resultant slurry was baked out at 80-100° C. The dried powder agglomerates from the baking were sieved through a −325 mesh screen so that any agglomerates were less than about 44 microns, and the powder mixture was formed into 1″ diameter pellets in a uniaxial press.

The pressed pellet was placed in a boron nitride (BN) crucible, which was covered and placed in a high temperature furnace having an argon atmosphere. Heating was carried out at about 125° C. per minute until a temperature of about 2350° C. was reached and then held at this temperature for about 30 minutes. Temperatures were measured by means of an optical pyrometer.

The sample was then cooled down to about 1800° C. at a rate of about 10° C. per minute, and thereafter, cooling to ambient was allowed to occur at about 200° C. per minute. Examination of the resultant crystalline structure showed an eutectic lamellar microstructure without any contamination; this indicates that BN is chemically compatible to these molten materials. The resultant structure exhibited good fracture toughness at a value of about 8 MPa\sqrt{m}.

### EXAMPLE 8

Another silicon carbide/boron carbide eutectic composition was formulated, using commercially available silicon carbide and boron carbide powder having particle sizes of less than about 2 microns, and the procedure generally as described in Example 1. 45 weight % silicon carbide and 55 wt % boron carbide are employed, and wet ball-milling was followed by sieving and uniaxial pressing. Heating was again carried out in a BN crucible at about 125° C. per minute and continued until a temperature of about 2350° C. was reached, at which temperature it was held for about 30 minutes.

The sample was again cooled down to about 1800° C. at a rate of about 10° C. per minute; thereafter, cooling to ambient was allowed to occur at about 200° C. per minute. Examination of the resultant crystalline structure showed an eutectic lamellar microstructure without any contamination. The resultant structure exhibited good fracture toughness at a value of about 4 MPa\sqrt{m}.

### EXAMPLE 9

Another titanium diboride/boron carbide eutectic composition was made using the procedure as generally described in Example 1. About 85 weight % boron carbide and 15 weight % titanium diboride were employed as in Example 3. A mixture of the two commercial powders was reduced in size to less than about 2 microns by wet milling, and the dried agglomerates were sieved through a −325 mesh screen. Heating was again similarly carried out to a temperature of about 2350° C. where it was held for about 30 minutes so that substantially the entire composition was in molten form. Initial cooling was then carried out as earlier described, i.e., at a rate of about 10° C. per minute down to about 1800° C., and then at about 200° C. per minute.

Examination of the resultant crystalline structure showed an eutectic lamellar microstructure without any contamination. The resultant structure exhibits good fracture toughness.

Although the invention has been described with regard to certain preferred embodiments which constitute the best mode presently known to the inventors for carrying out the invention, it should be understood that various changes and modifications as would be obvious to one having ordinary skill in this art may be made without deviating from the scope of the invention which is defined in the claims appended hereto. For example, although only examples of certain preferred refractory materials have been included, eutectics of other compounds in this class may also be used, as well as precursors that will provide these compounds upon heating. Likewise, although it is convenient and effective to employ extremely fine powders to facilitate thorough heating/melting, coarser powders may be used with slightly longer heating times. Particular features of the invention are emphasized in the following claims.

1. A method of making an armor body having a thickness sufficient to stop a bullet and a surface of greater dimension transverse to such thickness, which method comprises:
heating a mixture of particulate materials which will form an eutectic to a temperature sufficient to form a molten eutectic,
said mixture including at least:
(a) two carbides selected from boron carbide, silicon carbide, titanium carbide, tantalum carbide, tungsten carbide, zirconium carbide and hafnium carbide; or
(b) one of the above said carbides plus at least one boride of an element of group IVa, Va or VIa of the Periodic Table, and
cooling said molten eutectic under controlled conditions such that a body having a surface of such dimension is formed, which body has a directionally oriented lamellar microstructure,
whereby the resulting body has a high capacity to absorb impacts and has high fracture toughness.

2. The method of claim 1 wherein said mixture is heated to a temperature at least about 50° C. above the eutectic melting point thereof to create a substantially totally molten eutectic.

3. The method of claim 1 wherein said mixture is maintained molten for at least about 5 minutes and is cooled so that said lamellar microstructure is generally parallel to said surface.

4. The method of claim 3 wherein said molten mixture is initially cooled at a rate of between about 5° and about 15° C./minute until a temperature of about 1900° C. is reached.

5. The method of claim 4 wherein said heating and cooling are carried out in an inert atmosphere.

6. The method according to claim 1 wherein said mixture is heated in a crucible to a temperature above 2000° C., which crucible is coated with a barrier coating that prevents interaction between the molten eutectic and the material from which the crucible is made that might contaminate the resultant eutectic.

7. The method of claim 1 wherein said mixture includes particulate carbides or carbides and borides in amounts within at least about 5 weight % of a stiochiometric eutectic composition thereof.

8. The method of claim 1 wherein said mixture includes (a) particulate SiC and either TiB₂ or ZrB₂, (b) particulate SiC and B₄C; or (c) particulate B₄C and either ZrB₂ or TiB₂.

9. The method of claim 1 wherein said mixture includes two of said carbides and one said boride in particulate form.

10. The method of claim 9 wherein said mixture includes SiC, B₄C and TiB₂.

11. The method of claim 1 wherein said mixture includes particles of not greater than about 2 μm in size.

12. The method of claim 11 wherein said mixture is made by ball milling said particulate materials so that an intimate interdispersion of said particles is heated above the eutectic melting point.

13. An armor body which comprises a structure having a thickness sufficient to stop a bullet impacting against a surface of greater dimensions than such thickness and oriented generally perpendicular thereto, said structure consisting essentially of an eutectic composition which comprises either
(a) two carbides selected from boron carbide, silicon carbide, titanium carbide, tantalum carbide, tungsten carbide, zirconium carbide and hafnium carbide; or
(b) one of the above said carbides and at least one boride of an element of group IVa, Va or VIa of the Periodic Table,
said structure having a lamellar microstructure that is generally directionally oriented relative to said surface thereof, whereby said armor body has a high capacity to absorb impacts against said surface and a high fracture toughness.

14. The armor body of claim 13 wherein said eutectic comprises silicon carbide and either titanium boride or zirconium boride.

15. The armor body of claim 13 wherein said eutectic comprises silicon carbide and boron carbide.

16. The armor body of claim 13 wherein said eutectic comprises boron carbide and either titanium boride or zirconium boride.

17. The armor body of claim 13 wherein said eutectic comprises boron carbide, silicon carbide and titanium boride.

18. A dense, hard body having good fracture toughness, which body consists essentially of an eutectic composition that comprises either
(a) two carbides selected from boron carbide (B₄C), silicon carbide (SiC), titanium carbide (TiC), tantalum carbide (TaC), tungsten carbide (WC), zirconium carbide (ZrC) and hafnium carbide (HfC); or
(b) one of the above said carbides and at least one boride of an element of group IVa, Va or VIa of the Periodic Table,
said body having a lamellar microstructure that is generally directionally oriented relative to a main surface of said body, and said body having a high capacity to absorb impacts from a direction transverse to said main surface and a high fracture toughness.

19. The body of claim 18 which said body has a hardness of about 2400 kg/mm² on the Knoop scale and a fracture toughness at least about 4 MPa\sqrt{m}.

20. The body of claim 18 wherein said eutectic comprises B₄C, SiC and TiB₂.
